(19) United States
(12) Patent Application Publication
(10) Pub. No.: US 2024/0241511 A1
(43) Pub. Date: Jul. 18, 2024

(54) Computer System and Method of Building and Deploying a Customized Plant Asset Failure Prediction Engine

(71) Applicant: AspenTech Corporation, Bedford, MA (US)

(72) Inventors: Ajay Krishnalal Modi, Newton, MA (US); Héctor Luis Borras, Woburn, MA (US); John Carl Campbell, Katy, TX (US); Dorian F. Snyder, Nashua, NH (US); Brian Dias Barros, Lowell, MA (US); Patrick Daniel Aguiar Simoes, East Falmouth, MA (US)

(21) Appl. No.: 18/411,421

(22) Filed: Jan. 12, 2024

Related U.S. Application Data
(60) Provisional application No. 63/480,148, filed on Jan. 17, 2023.

(51) Int. Cl. G05B 23/02

(52) U.S. Cl. CPC G05B 23/0283; G05B 23/0216

(57) ABSTRACT

Computer system and method builds and deploys a custom industrial (chemical) processing plant asset failure prediction engine that integrates disparate calculation methods and information (data) sources. The diverse calculation methods improve quality and accuracy of the asset failure predictions by embedding domain knowledge and providing a holistic assessment of plant assets.

### RELATED APPLICATION

This application claims the benefit of U.S. Provisional Application No. 63/480,148, filed on Jan. 17, 2023. The entire teachings of the above application are incorporated herein by reference.

### BACKGROUND

In an industrial processing plant or facility (such as a petroleum processing refinery, chemical processing plant, pharmaceutical manufacturing facility, and the like) equipment failure and asset degradation may cause unplanned downtime or operational problems in the plant, often resulting in loss of production or decrease in product quality. Mitigating these adverse effects help manufacturers remain competitive and maximize profit margins.

### SUMMARY

Plant asset failure is a complex phenomenon that requires a wide range of information to predict and monitor in process industries. There may be many causes of asset degradation and ultimate failure. For example, mechanical parts in the equipment may be subjected to wear and tear or chemical and physical processes such as corrosion or fouling may result in asset deterioration.

Computer systems and models that predict plant asset failure and degradation are a powerful approach to managing these problems as plant personnel can take proactive action to either prevent these problems from occurring or mitigate their effects with as much lead time as possible. Given that plant assets can potentially fail or degrade in multiple ways, the ability to determine when these failure or degradation modes are likely to arise is dependent on the calculation methods and engineering information that can be brought to bear within the prediction engine. The more diverse the modeling information is, the better the quality and accuracy the prediction is likely to be. Operating conditions, thermodynamic and transport properties, mechanical behavior, material stresses and environmental influences are some examples of information relevant for asset failure prediction. Additionally, models that encapsulate these different kinds of information may range from first-principles engineering models to data-driven models based on machine learning. Furthermore, lack of easy access to these information sources by the prediction engine may impede their application. A source that is remotely located will need a mechanism in place to deliver its content to the prediction engine.

Predicting plant asset failure and degradation includes monitoring plant assets and collecting sensor data. Monitoring helps to collect data that may be correlated and used to predict behavior or problems in different components used in the same plant or in other plants and/or processes.

Applicants describe herein a system and method to configure, test, and deploy a plant asset failure predictive engine that can integrate a diverse and flexible set of calculation models and data sources. Embodiments provide a computer-based tool that designs models configured to indicate, demonstrate, or otherwise represent plant asset degradation, asset failure prediction, asset maintenance improvement, and/or unplanned asset availability as heretofore unachieved in the art. The computer-based tool automatically embeds into the models first principles and domain knowledge in a holistic fashion left unaddressed in the state of the art.

According to one embodiment, a computer-based system predicting failures and degradation in industrial processing plant assets is disclosed. For a given industrial processing plant formed of certain assets, the system comprises: (a) a prediction model configuration and testing assembly, and (b) a model execution engine. The assembly configures one or more prediction models corresponding to the plant assets. Different prediction models represent different plant assets and respective predicted failure and degradation. For a given plant asset, there may be multiple prediction models, i.e., different models for different physical properties or characteristics of the given plant asset. The model execution engine accesses diverse data sources and executes the prediction models. For execution of each prediction model, the execution engine applies a combination of diverse calculators and computes asset failure prediction of the plant asset corresponding to the prediction model. For different prediction models, the execution engine applies different combinations of diverse calculators. The diverse data sources and diverse calculators, in different combinations per prediction model, implement Applicant's holistic approach and overall enhance prediction quality as heretofore unachieved in the prior art.

One aspect relates to the system wherein the model execution engine deploys the one or more prediction models detecting asset failures and equipment degradation in real time operations of the given industrial processing plant.

Another aspect relates to the system wherein the model execution engine selects plant measurements or tags as inputs to the one or more prediction models, wherein the tags may be direct plant measurements or custom tags created either by aggregating and combining the measured tags or created by applying transformations or engineering computations to the measurements, and the system maps the tags to prediction model variables allowing the model to be driven by real-time data when deployed online.

According to an aspect, the system further comprises a database storing the computed asset failure predictions, the system treating the asset failure predictions as variables, and the database allowing the stored asset failure predictions to be used as inputs for another prediction model's calculation or for communication to the system's users and other parts of the system.

According to an aspect, the system allows the configuration and persistence of calculation parameters in the database.

According to an aspect, the system implements a flexible data structure for representing the prediction model's variables and parameters, thus allowing for a wide range of model types to be configured in the system.

According to another aspect, the system defines an extensible data format that allows it to exchange variable values, parameter values, and other information with the model execution engine.

Another aspect relates to the system wherein the model execution engine has a flexible interface enabling multiple data sources and multiple calculation methods to be combined together (holistically) to compute the asset failure predictions.

Another aspect relates to the system wherein the prediction model configuration and testing assembly trains each prediction model independently using any appropriate dataset and then deploys to the model execution engine, which may run locally on a same machine as the model client or remotely on a network location.

Yet another aspect relates to the system wherein for each configured prediction model, when the prediction model is deployed online, the prediction model is used to monitor plant degradation and detect asset failures, the online model being driven by plant measurements of the given industrial processing plant and by other information sources.

According to another embodiment, a method for predicting failures and degradation in industrial processing plant assets is disclosed. The method comprises: (a) configuring one or more prediction models corresponding to the plant assets, different prediction models representing different plant assets and respective predicted failure and degradation; (b) accessing diverse data sources; and (c) executing the prediction models, wherein the executing comprises applying a combination of diverse calculators computing asset failure prediction of the plant asset corresponding to the prediction model. The combination of diverse data sources and diverse calculators implement Applicant's holistic approach and enhance prediction quality.

According to one aspect, the method further comprises deploying the one or more prediction models detecting asset failures and equipment degradation in real time operations of the given industrial processing plant.

According to another aspect, the method further comprises selecting plant measurements or tags as inputs to the one or more prediction models, wherein the tags may be direct plant measurements or custom tags created either by aggregating and combining the measured tags or created by applying transformations or engineering computations to the measurements, and mapping the tags to prediction model variables allowing the model to be driven by real-time data when deployed online.

According to another aspect, the method further comprises storing the computed asset failure predictions, treating the asset failure predictions as variables, and allowing the stored asset failure predictions to be used as inputs for another prediction model's calculation or for communication to a system's users and other parts of the system.

According to yet another aspect, the method further comprises implementing a flexible data structure for representing the prediction model's variables and parameters, thus allowing for a wide range of model types to be configured.

According to one aspect, the method further comprises defining an extensible data format that allows the exchange of variable values and parameter values and other information with a model execution engine.

According to one aspect, the method further comprises combining multiple data sources and multiple calculation methods to compute the asset failure predictions.

Another aspect relates to the method wherein the configuring comprises training each prediction model independently using any appropriate dataset and then deploying to a model execution engine, which may run locally on a same machine as the model client or remotely on a network location.

Another aspect relates to the method wherein for each configured prediction model, when the prediction model is deployed online, the prediction model is used to monitor plant degradation and detect asset failures, the online model being driven by plant measurements of the given industrial processing plant and by other information sources.

According to yet another embodiment, a computer program product is disclosed, comprising: at least one non-transitory computer-readable storage medium providing computer executable instructions or program code. At least a portion of the provided software instructions cause a computer-based system to: (a) configure one or more prediction models corresponding to the plant assets, different prediction models representing different plant assets and respective predicted failure and degradation; (b) access diverse data sources; and (c) execute the prediction models, wherein the executing comprises holistically applying a combination of diverse calculators computing asset failure prediction of the plant asset corresponding to the prediction model. The combination(s) of diverse data sources and diverse calculators enhance prediction quality.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic view of the system architecture in one embodiment of the present invention.

FIG. 2 is a flow diagram of prediction model configuration in the embodiment (system) of FIG. 1.

FIG. 3 is a flow diagram of prediction model testing by or in the system of FIG. 1.

FIG. 4 is a flow diagram of online prediction model execution in embodiments such as the system of FIG. 1.

FIG. 5 is a flow diagram of prediction calculation in the model execution method of FIG. 4.

FIG. 6 is a schematic view of a computer network environment in which embodiments may be deployed.

FIG. 7 is a block diagram of a computer node in the computer network of FIG. 6.

FIG. 8 is a block diagram of a non-limiting example computer-based industrial process system embodying the principles of the present invention.

FIG. 9 illustrates a user interface where the user specifies input variables for a model being configured in an embodiment.

FIG. 10 illustrates the user interface where the user specifies output of variables computed by a model in an embodiment.

FIG. 11 illustrates the user interface where the user specifies server information, such as a URL, for the prediction model and parameters that a user may define to drive the prediction of an asset's performance in an embodiment.

FIG. 12 illustrates the user interface where the user specifies how the results from the model can be logically combined using domain knowledge to predict the onset of asset degradation in an embodiment.

FIG. 13 is a P-F (Performance-Failure) curve for an industrial asset, e.g., a pump illustrating enhanced prediction quality in embodiments.

### DETAILED DESCRIPTION

A description of example embodiments follows.

Unless otherwise defined, all technical and scientific terms used herein have the same meaning as commonly understood by one of ordinary skill in the art. Those skilled in the art to which the present disclosure pertains may make modifications resulting in other embodiments or aspects employing principles of the present invention without departing from its spirit or characteristics, particularly upon considering the foregoing teachings. In case of conflict, the present specification, including definitions, will control. In addition, the embodiments, aspects, and examples are illustrative only and not intended to be limiting. Other features and advantages of the present disclosure will be apparent from the following detailed description, and from the claims. While the present disclosure includes references to particular embodiments and aspects, modifications of system architecture, configurations, and the like apparent to those skilled in the art still fall within the scope as claimed.

Existing methods for predicting plant asset failures and operating issues are based on models that are either fixed in structure and calculation method or only nominally configurable.

As used herein, “plant asset” or “industrial processing plant asset” includes, and is not limited to, process control devices (e.g., controllers, field devices, etc.), rotating equipment (e.g., motors, pumps, compressors, drives), mechanical vessels (e.g., tanks, pipes, etc.), electrical power distribution equipment (e.g., switch gear, motor control centers), system units, subsystems, or any other processing plant equipment.

As used herein, “model” includes, and is not limited to, classification models, time series models, neural network models, linear regression models, logistic regression models, decision trees, support vector machines, Naive Bayes networks, k-nearest neighbor (KNN) models, k-means models, random forest models, association rule learning models, inductive logic programming models, reinforcement learning models, feature learning models, similarity learning models, sparse dictionary learning models, genetic algorithm models, rule-based machine learning models, learning classifier system models, or any combination thereof.

To determine prediction quality, the performance of the prediction model is evaluated in terms of various metrics such as accuracy, recall, precision, mean square error, etc., depending on the type of model. Prediction quality is also evaluated based on other factors including the amount of lead time before asset failure. For example, multiple models using the same historical sensor data may be generated but each with different lengths of time prior to predicted failure in order to identify at least one model with an acceptable accuracy at an acceptable prediction time before asset failure is expected to occur. If the evaluation of the model using a selected data set indicates that the model's predictions are inadequate with respect to quality, a decision to re-train the model may be made.

As used herein, “database” includes, and is not limited to, one or more databases configured as any suitable data store structure, such as a network, relational, hierarchical, multi-dimensional or object database. The database (or more generally data store) may be located within main memory (e.g., in the RAM) and/or within non-volatile memory (e.g., on a persistent hard disk). Database includes one or more databases deployed in an on-premise environment, cloud environment, and/or a combination thereof.

Embodiments of the present invention described herein are an improvement over prior art because each embodiment implements a method that supports the holistic combination and integration of a wide range of calculation models, data stores, and information sources to build a better engine for detecting and predicting plant asset failures. Examples of calculation methods that can be integrated into the prediction engine include: (a) rigorous process simulators such as Aspen Plus or Hysys (both by Assignee), (b) data-driven and machine learning models, and (c) systems that calculate thermodynamic and transport properties, such as Aspen Properties (by Assignee). These methods may be situated close to the prediction engine or remotely located in a cloud server. Other prediction calculations and methods in the art are suitable.

An embodiment of the present invention implements guided workflows for the configuration, testing, and deployment of an asset failure model (prediction model herein). The embodiment: (i) supports custom variable and parameter definitions for the model, (ii) allows model variables to be mapped to raw and transformed plant measurements, (iii) incorporates an extensible data format for variable sharing, persistence and communication, (iv) implements a flexible interface for failure predictions, and (v) supports the integration of open-form engineering models and information sources in a holistic approach to plant asset degradation and failure prediction.

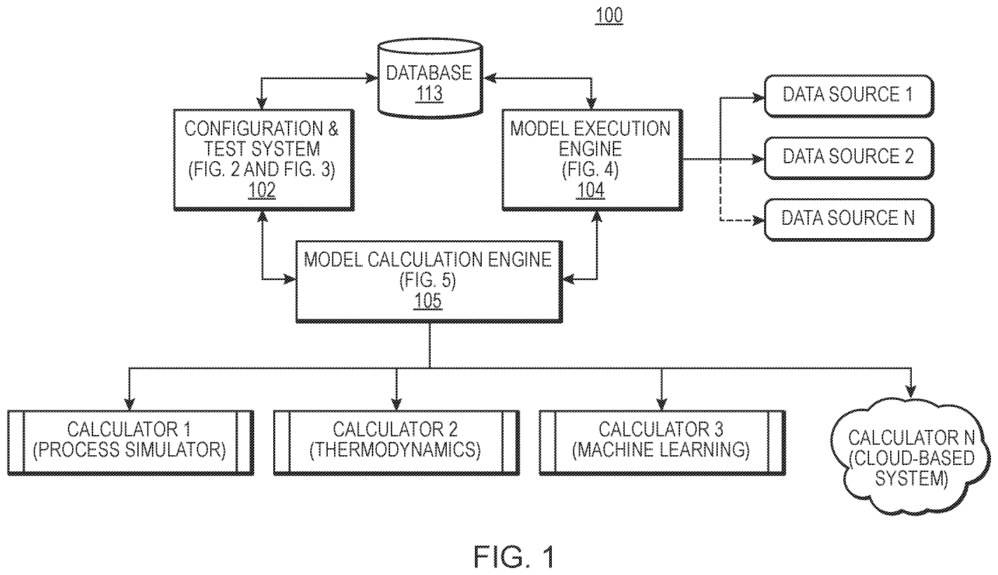

In particular, embodiments of the present invention provide a system 100 (FIG. 1 for non-limiting example) that implements an enhanced method for predicting failures and degradation issues in a plant asset of a given or subject industrial processing plant.

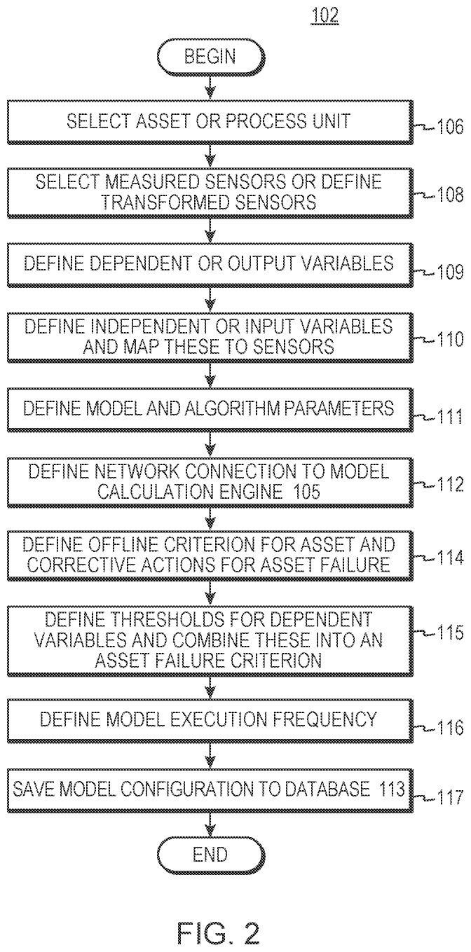

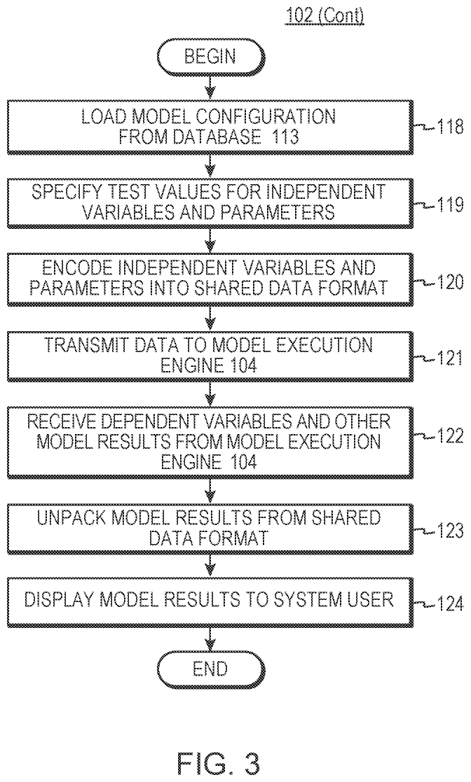

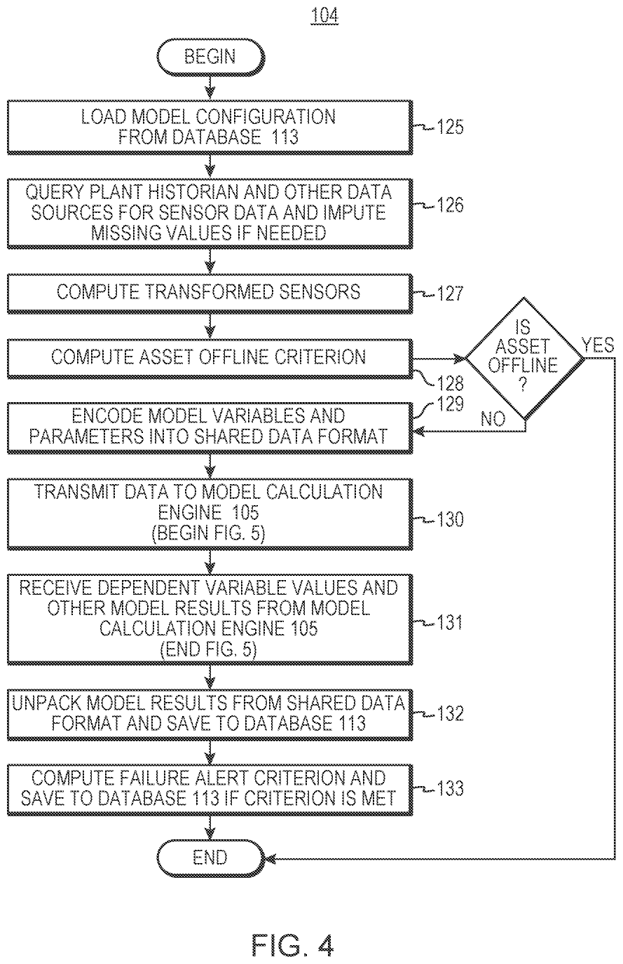

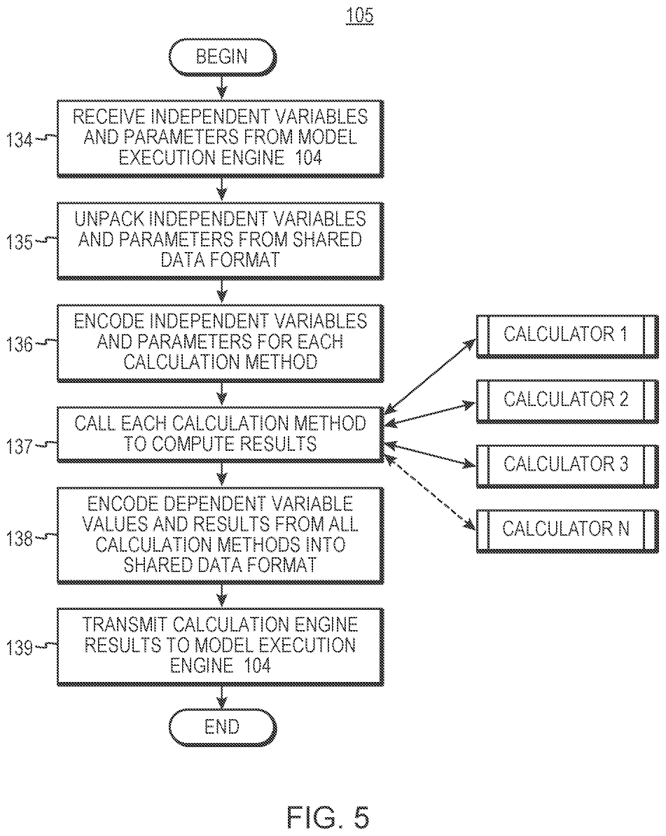

The system 100 supports guided workflows for configuring, testing, and deploying a model to detect asset failures and equipment degradation in real-time plant operations. FIGS. 2-5 are illustrative. FIG. 2 outlines workflow of the prediction model configuration by the system 100 of FIG. 1. FIG. 3 illustrates workflow of prediction model testing by the system 100. FIG. 4 illustrates system 100 workflow of online model execution, and FIG. 5 illustrates execution of the prediction (of certain asset failure or degradation) calculation therein.

In embodiments, the system 100 implements a method that allows plant measurements or tags to be selected as inputs to the model. The tags may be direct plant measurements or custom tags created either by aggregating and combining the measured tags or created by applying transformations or engineering computations to the measurements. The system 100 maps the tags to the prediction model's variables, allowing the model to be driven by real-time data when it is deployed online.

The system 100 exposes the model's predictions as variables. The predictions are persisted in a database 113, allowing them to be used as inputs for another model's calculations or for communication to the system's users and other parts of the system 100.

The system 100 allows the configuration and persistence of calculation parameters in the database 113.

The system 100 implements a flexible data structure for representing the prediction model's variables and parameters, thus allowing for a wide range of model types to be configured in the system.

The system 100 defines an extensible data format that allows it to exchange variable values, parameter values, and other information with a model execution engine 104 (FIGS. 1, 4, and 5).

A flexible interface to the model execution engine 104 allows multiple information sources (Data Source 1, . . . , Data Source N) and calculation methods (Calculator 1, . . . , Calculator N) to be combined together to compute the asset failure predictions as illustrated in FIG. 1. In this way, Applicant's holistic approach is implemented by a computer-based tool (system) 100.

The system 100 allows the model to be trained independently (at prediction model configuration and testing system 102) using any appropriate dataset and then deployed to the execution engine 104, which may run locally on the same machine as the model client or remotely on a network location that is reachable via standard computer protocols.

When deployed online, the model is used to monitor plant asset degradation and detect (or predict timing of) asset failures. The online model is driven by plant measurements (sensor readings) and other information sources.

As illustrated in FIG. 1, a subject industrial processing plant is monitored by a customized system 100 of the present invention. System architecture of systems 100 embodying the principles of the present invention include:
A prediction model configuration and testing system 102 (further elaborated in FIGS. 2 and 3);
A model execution engine 104; and
A model calculation engine 105,
   each coupled for communication with a database 113 (as discussed above).

Each component of the system architecture, such as configuration and testing system 102, model execution engine 104, and model calculation engine 105, is installed on one or more underlying computing platforms, including on-premise platforms, cloud computing platforms and/or a combination thereof, such as hybrid cloud platforms. An on-premise platform is a computing platform that may be installed and operated on the premises of an entity such as a customer of the on-premise platform. A cloud computing platform may span wide geographic locations, including countries and continents. The service and/or application components (e.g., tenant infrastructure or tenancy) of the cloud computing platform may include nodes (e.g., computing devices, processing units, or blades in a server rack) that are allocated to run one or more portions of a tenant's services and applications. When more than one service or application is being supported by the nodes, the nodes may be partitioned into virtual machines or physical machines.

As illustrated in FIG. 1, communication between the respective components of system 100 is possible using an API (Application Programming Interface) implemented to send and/or receive information between, for example, the model execution engine 104 and model calculation engine 105. Configuration of such API's employ technology and techniques that are common or known in the art and are within the purview of one skilled in the art given the disclosure herein.

The model execution engine 104 accesses various diverse data sources and employs model calculation engine 105 to compute asset failure predictions for the subject plant. As described above, model calculation engine 105 utilizes a variety of diverse calculators 1, . . . , N (e.g., calculation methods, simulators, and the like) that improve quality and accuracy of the asset failure predictions. Different calculation methods and simulators known in the art are suitable. For non-limiting example, calculation engine 105 may utilize the following as calculators. Aspen Plus, Aspen Properties, Aspen Hysys (each trademarks of Assignee) are some non-limiting examples of calculators based on first-principles or engineering domain knowledge. Neural networks, regression models, clustering models and classification models are non-limiting examples of calculators based on machine learning.

The system 100 configures one or more prediction models using the configuration and testing system 102 whose workflow is detailed in FIGS. 2 and 3. Specifically, the configuration and testing system 102 configures a prediction model according to the flow diagram steps of FIG. 2, and tests a configured prediction model according to the flow diagram steps of FIG. 3. The prediction model represents a certain plant asset and predicts operation of the same including potential failure and degradation. Different prediction models represent different plant assets and respective operation and predicted failure/degradation. For a given plant asset, there may be multiple prediction models where different models represent or are indicative of different physical characteristics of the given asset.

Prediction model configuration and testing system 102 includes a workflow for configuring a prediction model to detect asset failures and equipment degradation in real-time plant operations. In particular, a given industrial plant is formed of multiple and various assets (equipment, subsystems, working components, industrial process unit, and the like). For each plant asset, the prediction model configuration and testing system 102 configures one or more prediction models for respective physical aspects or characteristics of the asset, such as temperature within boundaries, pressure relative to thresholds, output (product or residual) volume, or similar, for non-limiting example. The configuration workflow includes, and is not limited to, the stages as illustrated in FIG. 2. The configuration workflow begins at stage 106 where the plant asset or industrial process unit is selected for modeling. For non-limiting example, the plant asset could be an air-cooled heat exchanger, a pump, a compressor, a reactor, a turbine, or a column, etc. In one embodiment, an end user interactively selects the plant asset at step 106 through a user interface of prediction model configuration and testing system 102 (or generally system 100).

At stage 108, system 102 selects measured sensors providing raw asset measurement readings and/or transformed sensors providing transformed readings. For example, sensors may be utilized to monitor flow rates, the presence of corrosive contaminants, pH levels, and/or temperature within the heat exchanger process streams. The sensors may be positioned on various components of the plant and may communicate wirelessly or wired with one or more of the information source platforms (Data Source 1, . . . , Data Source N) illustrated in FIG. 1. The sensors may also filter measurements such as those values that are statistically relevant or of-interest to the system environment. As a result, one or more of the sensors may include a processor (or other circuitry that enables execution of computer instructions) and a memory to store those instructions and/or filtered data values. The processor may be embodied as an application-specific integrated circuit (ASIC), FPGA, or other hardware- or software-based module for execution of instructions.

At stage 109, system 102 defines and selects dependent or output variables for the prediction model being configured. At stage 110, system 102 defines independent or input variables and maps them to raw and transformed plant sensor measurements. Stage 111 involves user interactively or otherwise defining prediction model parameters and algorithm parameters. For non-limiting example, an output variable P may be a linear function f of input variables Xᵢ such as P=cΣf(Xᵢ) for i=1, 2, . . . , n, and where c is a predefined (user-defined parameter) constant. The c constant is a non-limiting example of a prediction model parameter. In one embodiment, algorithm parameters are represented as conditionals. For example, if the plant is making product A, use function (equation) A, and if the plant is making product B, use function (equation) B. In another embodiment, the prediction model may be a system of equations, known or common in the industry. For non-limiting example, the variable P may represent the probability of equipment failure or a measure of asset degradation, e.g., heat transfer coefficient in a heat exchanger. A relatively lower (or decreasing over time) heat transfer coefficient may indicate that the heat exchanger is fouling. A computed rate of decline of the heat transfer coefficient (i.e., change in heat transfer coefficient over change in time) can then be used in the system of equations to arrive at onset of heat exchanger failure, and in turn probability of asset failure or a measure of asset degradation.

Next, stage 112 defines a network connection to model calculation engine 105. For non-limiting example, for an HTTP or HTTPS protocol, the connection may be established via a URL which includes a domain name, a port and a resource path. In one embodiment, stage 112 supports and responsively receives user interactive input specifying such URL, domain name, etc.

Stage 114 defines offline criterion for a given plant asset and corrective actions for asset failure. For non-limiting example, through a user interface, at step 114 a user inputs, selects, or otherwise defines an offline condition indicative of when an asset is not in use. For example, if the asset is not consuming any power, the system 100 can deem the asset to be offline. The user may define this condition in the user interface at step 114. In addition, for non-limiting example, the user defines or otherwise specifies in the user interface at step 114 corresponding corrective actions such as a set of guidelines for addressing the predicted asset failure or degradation, e.g., clean the heat exchanger.

Stage 115 defines thresholds for dependent variables and combines the thresholds into an asset failure criterion. For non-limiting example, based on user interactive input, step 115 defines or otherwise configures acceptable quantitative boundaries or numeric ranges for output P in our above example. For non-limiting example, step 115 combines thresholds using mathematical expressions and defines a respective asset failure criterion. For example, a model may be configured to calculate several output variables (P values). The user interactively (through a user interface at step 115) specifies combinations of P values that define an impending asset failure. For non-limiting example, using a Boolean expression, IF (P1>80) AND (P2<35), then the system 100 in model execution mode is to inform the plant operator of an impending issue with the asset. Stage 116 defines model execution frequency. For non-limiting example, the execution frequency may be determined based on the execution time for the prediction model and/or the resource load capability of the calculation engine.

The configuration workflow of system 102 concludes at stage 117 where stage 117 saves the prediction model configuration to database 113. System 102 iterates with this workflow for each prediction model of a subject plant asset and for the one or more models of the different assets in the given industrial plant.

Prediction model configuration and testing system 102 further includes a workflow for testing the above configured and saved prediction models to detect asset failures and equipment degradation in real-time plant operations. The testing workflow includes, and is not limited to, the stages as illustrated in FIG. 3. The testing workflow begins at stage 118 where the subject prediction model configuration is loaded from database 113.

At stage 119, test values for independent variables and parameters are specified. In at least one embodiment, the test values for independent variables and parameters are user input by user interactive interface, graphical user interface, data file import, and/or other known techniques. The independent variables and parameters may be, for non-limiting example, temperature values, pressure values, flow rate at time t, regression coefficients, etc. Furthermore, the variables and parameters may be learned during training for a machine learning model, or parameters in a first-principles model, e.g., molecular weight of a material component.

In response, stage 120 encodes independent variables and parameters into a shared data format, allowing ease of accessing, storing, transmitting, and recovering data. This is accomplished in one embodiment using fixed-length encoding, variable-length encoding, JSON encoding, XML encoding, or other common data encoding techniques resulting in JSON, XML, UTF-8, UTF-16, or UTF-32 data format or similar known in the art. Stage 120 stores results of the data encoding in database 113 or local memory. For example, in one embodiment the results of the model calculation, i.e., the values of the output variables, are transmitted back to the model execution engine 104 in the encoded format, e.g., JSON, and in turn the model execution engine 104 responsively stores the model results (values of the output variables) in database 113.

Stage 121 transmits the formatted data resulting from step 120 to model execution engine 104. In turn, model execution engine 104 runs the prediction model loaded at step 118 and employs the test values received from the output of step 121. Stage 122 receives dependent variables and other model results from model execution engine 104 output from stage 121.

In response, stage 123 unpacks the received model results from the shared data format. Known unpacking techniques are utilized. The configuration workflow 102 concludes at stage 124 where system 102 displays the prediction model results to the system user via a user interface. Other forms of outputting the model results, i.e., in a data file, transmitted to another program, and the like for non-limiting example, are in the purview of the skilled in the art.

After the prediction models are configured and tested, system 100 (via model execution engine 104 and model calculation engine 105) executes the prepared prediction models during online operation of the subject industrial processing plant. The steps of the online model execution are illustrated and detailed in FIGS. 4 and 5. For each asset prediction model, the online model execution engine 104 performs the steps (method) of FIG. 4 and calls on the model calculation engine 105 to perform the steps (method) of FIG. 5. For each asset prediction model, calculation engine 105 employs a combination of multiple diverse calculators. The output of the combined calculators is used to form the computed results, i.e., asset failure predictions of the plant asset corresponding to the prediction model. Calculation engine 105 may use different combinations of diverse calculators for different asset prediction models. In this way, calculation engine 105 (system 100 generally) implements the holistic approach of Applicants. Calculators common in the art are suitable for combined use by calculation engine 105. For non-limiting example, the calculators and calculation methods may include rigorous process simulators (such as, Aspen Plus® or Hysys®, both by Assignee), data driven and machine learning models (such as regression models, neural networks, rule-based models, classification models and clustering models), and physical property calculation systems that calculate thermodynamic and transport properties, and the like. For non-limiting example, physical property calculation systems may include: Aspen Properties (trademark of Assignee), and the like.

Model execution engine 104 outputs the resulting (calculated) failure or degradation predictions of the different plant assets/certain assets. Model execution engine 104 provides or feeds such output to control systems, plant scheduling systems, or other systems of the subject industrial processing plant, supporting or rendering views, warnings, notices, etc. in display or other interfaces to plant engineers and other end-users, etc.

FIG. 4 illustrates a workflow of online model execution following model deployment to model execution engine 104. The execution workflow begins at stage 125 where the model configuration (generated, tested, and stored per FIGS. 2 and 3 described above) is loaded from database 113. At stage 126, model execution engine 104 queries plant historian and other data sources for sensor data and imputes missing values if needed. Model execution engine 104/step 126 employs imputation algorithms such as , but not limited to, mean, median, mode, multivariate imputation by chained equations (MICE), k nearest neighbors, MissForests, iterative imputation algorithms, regression imputation algorithms, and other similar techniques known in the art.

At stage 127, transformed sensor data are computed. That is step 127 applies normalization, Fourier transform, and/or other common in the art data transformation to raw sensor data readings or measurements.

Based on offline criterion defined at step 114 (in configuration system 102) for the system 100 or model execution engine 104, stage 128 determines whether a plant asset is offline. For non-limiting example, if the cooling water or steam flow rate to the heat exchanger is zero, this may indicate that the heat exchanger is offline. Other measurable indicators or measured physical states are suitable. If the plant asset is offline, the workflow of model execution engine 104 concludes. If the asset is not offline, the workflow continues at step 129. Step 129 encodes model variable values and parameter values into the shared data format. To accomplish this, step 129 involves using fixed-length encoding, variable-length encoding, JSON encoding, XML encoding, or other common data encoding techniques, resulting in JSON, XML, UTF-8, UTF-16, or UTF-32 data format or similar known in the art.

Stage 130 corresponds to the beginning of FIG. 5 where model execution engine 104 transmits data to model calculation engine 105. Stage 131 corresponds to the end of FIG. 5 where dependent variable values and other model results output from model calculation engine 105 are received by model execution engine 104. In response, stage 132 unpacks model results from the shared data format and saves the calculated or otherwise generated model results in the unpacked format to database 113.

Stage 133 applies failure alert criterion to the model results of step 132. For non-limiting example, the failure alert criterion may include certain thresholds (e.g., more likely than not, likely within the next logical time period, and similar) for prediction model results. If failure alert criterion is met, stage 133 saves an indication of the failure alert for the plant asset corresponding to the subject prediction model. In turn, the execution workflow concludes.

FIG. 5 illustrates a calculation workflow for computing asset failure predictions and implementing model calculation engine 105. The calculation workflow (generally, method of calculation engine 105) begins at stage 134. In particular, step 134 receives independent variables and parameters from model execution engine 104 transmitted at step 130 of FIG. 4. In response, stage 135 unpacks the received independent variables and parameters from the shared data format. Known or common in the art techniques for unpacking from the shared data format are employed.

Stage 136 encodes independent variables and parameters for each calculation method. In turn, Stage 137 calls each calculation method (Calculator 1, . . . , Calculator N) to compute results. In one embodiment, the subject model could be an aggregation of several sub-models or calculation methods. For example, if the scope of the model includes multiple plant assets or sub-components of a single asset, each calculation method could compute one or more output variables. For non-limiting example, if a pump is connected to a heat exchanger, the pump model may compute the pump efficiency while the heat exchanger model may compute the heat transfer coefficient.

In response to the output (calculator results) from step 137, Stage 138 encodes dependent variable values and results from all calculation methods into the shared data format. Stage 138 in one embodiment uses fixed-length encoding, variable-length encoding, JSON encoding, XML encoding, or other similar techniques for encoding the dependent variable values and calculated results. The calculation workflow concludes at stage 139 where calculation engine 105 transmits results to model execution engine 104 (i.e., step 131 of FIG. 4).

### Computer Support

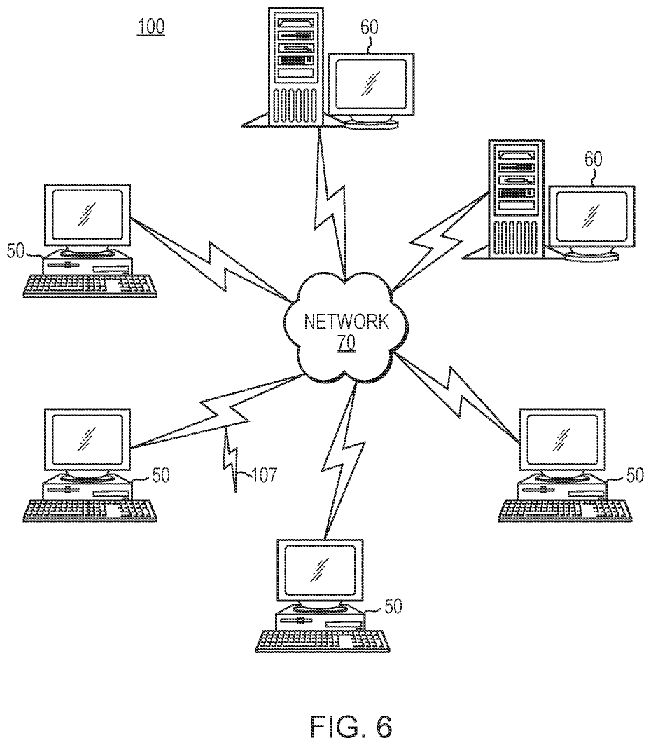

FIG. 6 illustrates a computer network or similar digital processing environment in which embodiments 100 of the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), cloud computing servers or service, a worldwide collection of computers, Local area or Wide area networks, and gateways that currently use respective protocols (TCP/IP, Bluetooth, etc.) to communicate with one another. Other electronic device/computer network architectures are suitable.

The network 70 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 1G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 70 may be any type and/or form of network. The geographical scope of the network 70 may vary widely and the network 70 can be a body area network (BAN), a personal area network (PAN), a local-area network (LAN), e.g. Intranet, a metropolitan area network (MAN), a wide area network (WAN), or the Internet. The topology of the network 70 may be of any form and may include, e.g., any of the following: point-to-point, bus, star, ring, mesh, or tree. The network 70 may be an overlay network which is virtual and sits on top of one or more layers of other networks. The network 70 may be of any such network topology as known to those ordinarily skilled in the art capable of supporting the operations described herein. The network 70 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 70 may be a type of a broadcast network, a telecommunications network, a data communication network, or a computer network.

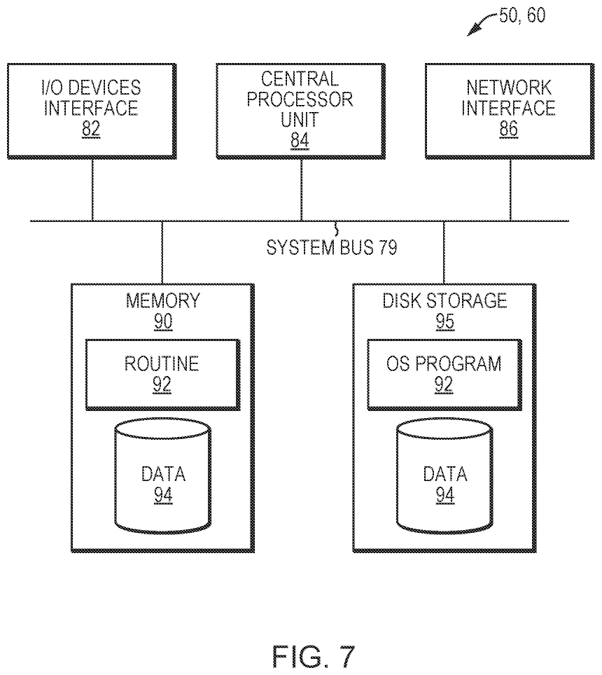

FIG. 7 is a diagram of the internal structure of a computer (e.g., client processor/device 50 or server computers 60) in the computer network of FIG. 6. The computer network may comprise any one or more of the following nodes: any workstation, telephone, desktop computer, laptop or notebook computer, netbook, Ultrabook, tablet, server, handheld computer, mobile telephone, smartphone and/or forms of computing, telecommunications or media device that is capable of communication. The computer node has sufficient processor power and memory capacity to perform the operations described herein. In some embodiments, the computer node may comprise different processors, operating systems, and input/output devices.

In one embodiment, each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 6). Memory 90 provides volatile storage for computer software instructions 92 and data 94 used to implement an embodiment of the present invention (e.g., the plant asset prediction model configuration, testing, and deployment methods, system, techniques, and program code detailed above at 100, 102, 104, 105 in FIGS. 1 through 5). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

In other embodiments, the program product 92 may be implemented as a so-called Software as a Service (SaaS), or other installation or communication supporting end-users.

Specific details are given in the above description to provide a thorough understanding of the embodiments. However, it is understood that the embodiments may be practiced without these specific details. For example, the computer node in FIG. 7 is shown as a block diagram in order not to obscure the embodiments in unnecessary detail.

The various illustrative embodiments described in connection with the disclosure herein may be implemented in hardware, software, or a combination thereof. For a hardware implementation, the embodiments may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted although a flowchart (such as those of FIGS. 2-5) may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a computer-readable storage medium. A code segment or machine executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

Computer-readable medium includes both non-transitory computer storage medium and communication medium including any medium that facilitates transfer of a computer program from one place to another. A non-transitory computer-readable storage medium includes any available medium that can be accessed by a general purpose or special purpose computer. By way of example, and not limiting, non-transitory computer-readable storage medium can comprise Random Access Memory (RAM), read Only Memory (ROM), electrically Erasable Programmable Read Only Memory (EEPROM), flash memory, compact Disc (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital Subscriber Line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital Versatile Disc (DVD), floppy disk and blu-ray disc where disks usually reproduce data magnetically, while discs reproduce data optically with lasers. Combinations of the above are also included within the scope of computer-readable medium.

Other embodiments of the present invention include modifications made to the system, method, computer program product, and the like to prioritize memory usage or memory footprint goals, utilization goals for other resources such as CPUs, prediction-time goals (e.g., the elapsed time for a prediction run of the model), prediction-time variation goals (e.g., reducing the differences between model prediction times for different observation records), prediction quality goals, budget goals (e.g., the total amount that a user wishes to spend on model execution, which may be proportional to the CPU utilization of the model execution or to utilization levels of other resources), revenue/ profit goals, and so on.

As used herein, the articles “a,” “an,” and “the” are used herein to refer to one or to more than one (i.e., to at least one) of the grammatical object of the article. By way of example, “an element” can mean one element or more than one element.

Also, the use of “or” means “and/or” unless stated otherwise. Similarly, “comprise,” “comprises,” “comprising” “include,” “includes,” and “including” are interchangeable and not intended to be limiting.

### Non-Limiting Examplary I Industrial Process System

### Example Network Environment for Plant Processes

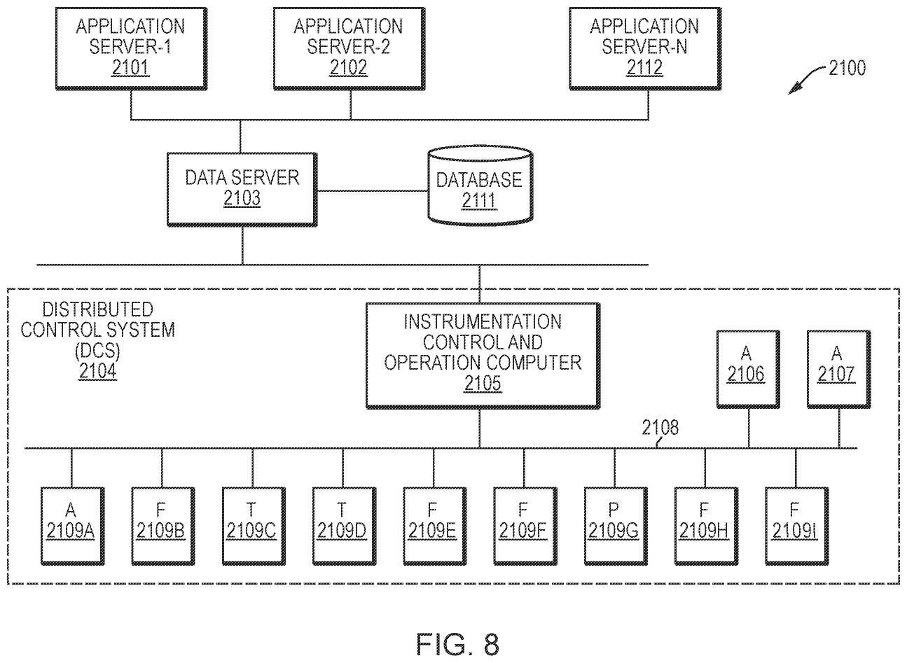

FIG. 8 illustrates a block diagram depicting an example network environment 2100 for monitoring plant processes in many embodiments such as system 100 of FIG. 1. The diagram of FIG. 8 is an embodiment of the computer network environment of FIG. 6 for modeling, monitoring, and/or controlling a plant process of a physical plant, such as a petrochemical plant, a chemical processing plant, or the like. The plant process may be any chemical process, petroleum refinery process, pharmaceutical process, and the like. System computers (servers) 2101, 2102 may operate as controllers communicatively coupled to the plant equipment affecting the plant process. In some embodiments, each one of the system computers 2101, 2102 may operate in real-time as a controller alone, or the computers 2101, 2102 may operate together as distributed processors contributing to real-time operations as a single controller. In other embodiments, additional system computers (servers) 2112 may also operate as distributed processors contributing to the real-time operation as a controller. System computers 2101, 2102, . . . , 2112 are programmed to carry out the functions and operations of system 100 detailed above in FIGS. 1-5.

As an example of previously detailed stage 126 of FIG. 4, the system computers 2101 and 2102 may communicate with the data server 2103 to access collected data for measurable process variables from a historian database 2111. The data server 2103 may be further communicatively coupled to a distributed control system (DCS) 2104, or any other plant control system, which may be configured with instruments 2109A-2109I, 2106, 2107 that collect data at a regular sampling period (e.g., one sample per minute) for the measurable process variables. Instruments 2106, 2107 are, for non-limiting example, online analyzers (e.g., gas chromatographs) that collect data at a longer sampling period. The instruments may communicate the collected data to an instrumentation computer 2105, also configured in the DCS 2104, and the instrumentation computer 2105 may in turn communicate the collected data to the data server 2103 over communications network 2108. The data server 2103 may then archive the collected data in the historian database 2111 for model calibration and inferential model training purposes. The data collected varies according to the type of target process (plant process).

The collected data may include measurements for various measurable process variables. These measurements may include, for non-limiting example, a feed stream flow rate as measured by a flow meter 2109B, a feed stream temperature as measured by a temperature sensor 2109C, component feed concentrations as determined by an analyzer 2109A, and reflux stream temperature in a pipe as measured by a temperature sensor 2109D. The collected data may also include, for non-limiting example, measurements for process output stream variables, such as, for example, the concentration of produced materials, as measured by analyzers 2106 and 2107. The collected data may further include measurements for manipulated input variables, such as, for example, reflux flow rate as set by valve 2109F and determined by flow meter 2109H, a re-boiler steam flow rate as set by valve 2109E and measured by flow meter 21091, and pressure in a column as controlled by a valve 2109G. The collected data reflect, for non-limiting example, the operation conditions of the representative plant during a particular sampling period. The collected data is archived in the historian database 2111 for model calibration and inferential model training purposes. The data collected varies according to the type of target process. System 100 and embodiments copy or share the collected data of historian database 2111 to database 113 of FIG. 1. In this way, configuration and testing system 102, model execution engine 104, and/or model calculation engine 105 use the collected data archived in historian database 2111 to predict plant asset failure and degradation.

The system computers 2101 or 2102 may execute various types of process controllers for online deployment purposes. The process controllers generate one or more linear and non-linear models defining the behavior of the plant process. The output values generated by the controller(s) on the system computers 2101 or 2102 may be provided to the instrumentation computer 2105 over the network 2108 for an operator to view, or may be provided to automatically program any other component of the DCS 2104, or any other plant control system or processing system coupled to the DCS system 2104. Alternatively, the instrumentation computer 2105 can store the historical data 2111 through the data server 2103 in the historian database 2111 and execute the process controller(s) in a stand-alone mode. Collectively, the instrumentation computer 2105, the data server 2103, and various sensors and output drivers (e.g., 2109A-2109I, 2106, 2107) form the DCS 2104 and can work together to implement and run the presented application, i.e., the invention system and method 100.

The example architecture 2100 of the computer system supports the process operation in a representative plant and the collection of sensor data for predicting plant asset failure and degradation. In this embodiment, the representative plant may be, for example, a refinery or a chemical processing plant having a number of measurable process variables, such as, for example, temperature, pressure, and flow rate variables. It should be understood that in other embodiments a wide variety of other types of technological processes or equipment in the useful arts may be involved.

### Non-Limiting Examplary II Plant Assets

It is understood that the skilled artisan may modify any of the examples, protocols and procedures in order to implement embodiments of the present invention as described herein.

### EXAMPLE 1: HEAT EXCHANGER

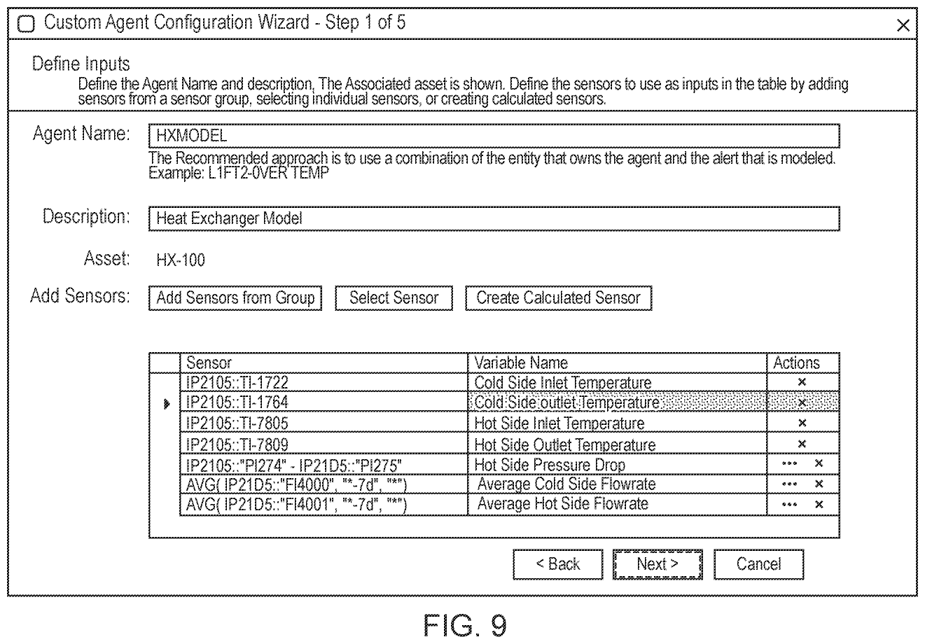

FIG. 9 is a non-limiting example of a user interface where the user defines or otherwise specifies input variables for a prediction model of interest. In particular, FIG. 9 illustrates how each input variable in a model being configured to represent a heat exchanger is mapped to a sensor (also known as tag). In an embodiment, each tag can reside in a different data historian in the plant, and there are no restrictions on the number of input variables. In another embodiment, input variables may be mapped to either raw sensors, e.g., “Cold Side Inlet Temperature” is mapped to tag TI-1722 from data source IP21DS, or to calculated sensors, e.g., “Hot Side Pressure Drop” is mapped to the difference of two individual pressure tags (PI274 and PI275) and “Average Cold Side Flowrate” is the average flowrate for the cold side (FI4000) of the heat exchanger over the last seven days.

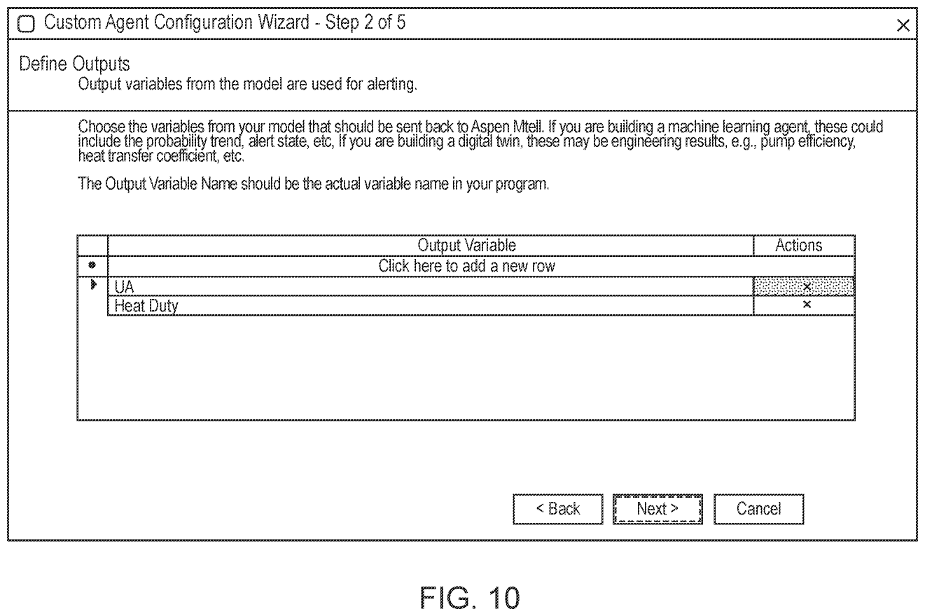

FIG. 10 illustrates the user interface where the user specifies output of variables computed by a model. For non-limiting example, shown are two output variables, UA (overall heat transfer coefficient multiplied by heat transfer area) and Heat Duty. In embodiments, there are no restrictions on the number of output variables that can be specified through the user interface. Asset degradation can often be better predicted with higher confidence by computing multiple variables and then applying logic based on domain knowledge to these results. Such improved predictions are due to Applicant's holistic approach as implemented by the computing of multiple variables and embedding of domain knowledge.

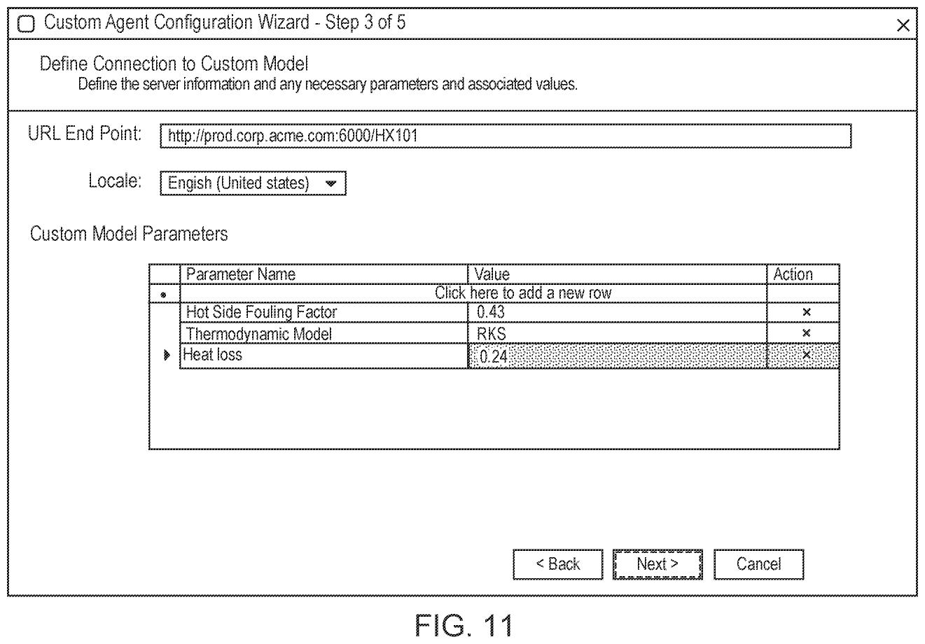

FIG. 11 illustrates the user interface where the user specifies or otherwise defines parameters that drive the prediction of the asset's performance. For non-limiting example, shown in FIG. 11 are three user specified parameters: Hot Side Fouling Factor, Thermodynamic Model, and Heat Loss. The Hot side Fouling Factor has a user-defined value of 0.43. The Thermodynamic Model parameter has an associated value of RK5 as set by the user in the user interface. The Heat Loss parameter has a user-defined value of 0.24. In embodiments, there are no restrictions on the number of parameters that can be specified by the user.

Based on the above user specified input variables, output variables, and parameters of FIGS. 9-11, system 100 configures one or more prediction models for the subject plant asset utilizing equations and mathematical relationships representative of the operations and physics-based behavior corresponding to the plant asset. The use of multiple, various computed variables and embedding/applying first principles and domain knowledge to holistically arrive at a prediction of asset failure or degradation is heretofore unachieved and not contemplated by the prior art.

The user also specifies in the user interface in FIG. 11 server information such as the URL for the prediction model(s). This allows the model to be located anywhere reachable by the execution engine 104, e.g., in the cloud, in a container, on another machine on the network, etc. The model(s) can be as simple or complex as is required for the prediction of the asset's performance. There are no restrictions on the language in which the model is implemented, e.g. Python. In an embodiment, a prediction model may be a machine learning model or a first-principles model, or some combination thereof. Information (input variables, output variables, parameters) required to run the model is packaged in a flexible data format, e.g. JSON, and transferred to the model. Results are returned to the execution engine 104 in a similar fashion.

Restated, after model configuration, system 100 deploys the prediction models in conjunction with operation of the subject plant and plant process. Execution engine 104 executes the prediction models using various online (real time) sensor data, historian database data, and a range of calculators as described above. Execution engine combines or otherwise assesses results and output variables of the executed prediction models according to user specification predefined (i.e., before model deployment) in or through the user interface during model configuration described next.

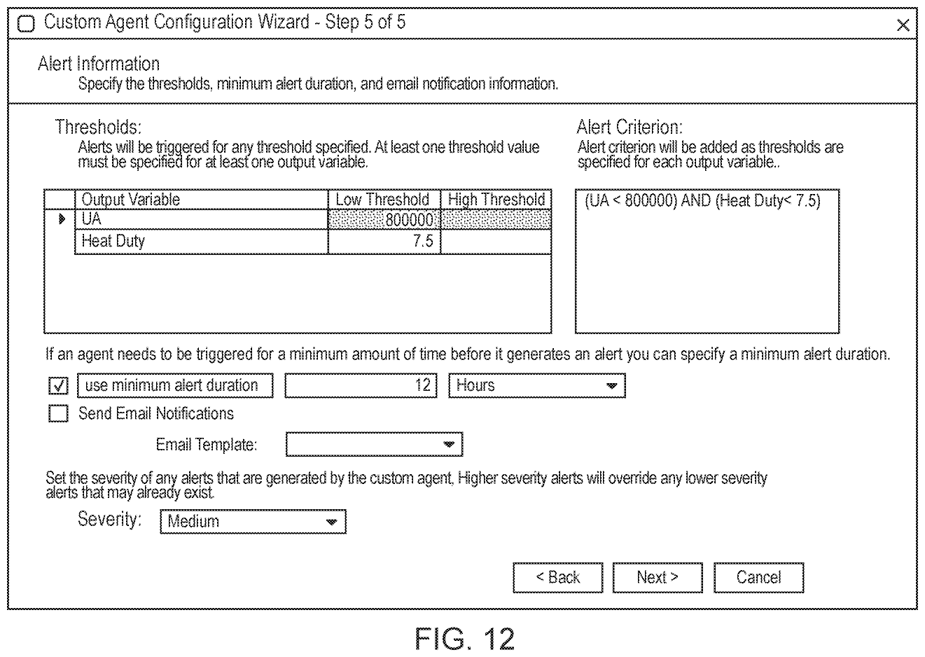

FIG. 12 illustrates the user interface where the user specifies how results from the prediction models can be logically combined using domain knowledge to define failure alert criterion and to predict the onset of asset degradation. Such domain knowledge based combinations of model results provide the holistic view and assessment of the state of the plant assets that are key to Applicant's approach. For non-limiting example, the user may specify in the user interface that if output variable UA is at a low threshold (UA<800000) and output variable Heat Duty is at its respective low threshold (Heat Duty<7.5) and these conditions persist for 12 hours, then generate an alert to the plant operator or maintenance engineer of an impending performance problem. In the user interface, the user may further set relative severity or priority of sorts for alerts (e.g., defining which alert overrides another alert).

### EXAMPLE 2: PUMP

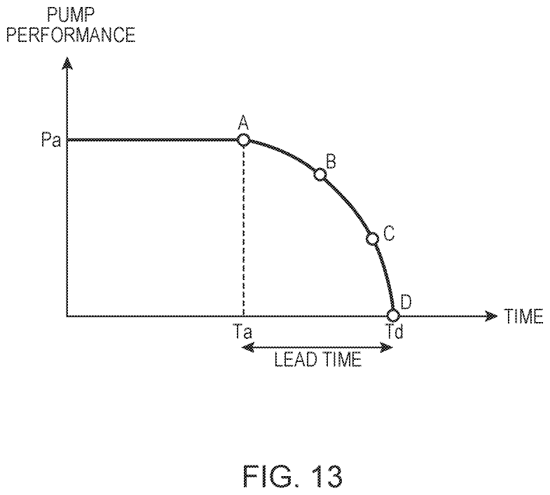

FIG. 13 is an example of a P-F (Performance-Failure) curve for an industrial asset, e.g., a pump. According to the example, until time Ta, the pump is performing as expected. Point A is the earliest point at which a degradation of the pump's performance is detectable. At points B and C, the pump performance has degraded further and at Point D, which occurs at time Td, the pump has failed. The duration (Td-Ta) is the lead time for the failure.

For non-limiting example, predicting the performance of the pump and the time at which it is likely to fail depends upon the calculation methods and data sources that can be brought to bear in the model computation. The more diverse these methods and data sources are, the more accurate the estimation of the pump performance and lead time are likely to be. In embodiments, such diverse calculation methods and data sources are employed in plant asset model (e.g., pump model) configuration and execution.

### EXAMPLE 3: REFINERY

An embodiment of system 100 predicts failures with nearly 30 days of lead time for scheduling maintenance and shifting production. The diverse data sources and calculators enhance prediction quality and allow a U.S. refinery and chemical manufacturer to adapt their work processes overall, changing the way staff look at root cause of failure analysis (RCFA).

For non-limiting example, presented below is pseudocode that illustrates an example model that applies multiple data sources and calculation methods to predict asset degradation:
1. Vendor database that holds asset materials of construction and their properties
2. Data lake that stores heating and cooling utility data
3. Thermodynamic system to calculate fluid properties
4. Cloud-based weather API
5. Machine learning regression model
6. Rigorous chemical simulator

```
procedure assetDegradation(inputs, parameters)
  /* Extract input variable values */
  coldSideInletTemp <-- unpackColdSideInletTemp(inputs)
  coldSideOutletTemp <-- unpackColdSideOutletTemp(inputs)
  hotSideInletTemp <-- unpackHotSideInletTemp(inputs)
  hotSideOutletTemp <-- unpackHotSideOutletTemp(inputs)
  coldSideFlowrate <-- unpackColdSideFlowrate(inputs)
  hotSideFlowrate <-- unpackHotSideFlowrate(inputs)
  /* Extract parameter values */
  thermoModel <-- unpackThermoModel(parameters)
  heatLoss <-- unpackHeatLoss(parameters)
  hotSideFoulingFactor <-- unpackFoulingFactor(parameters)
  coldUtility <-- unpackColdUtility(parameters)
  forecastWindow <-- unpackForecastWindow(parameters)
  /* Retrieve stainless steel properties from a vendor database */
  ssConductivity <-- queryVendor( )
  /* Retrieve cold utility properties from a remote data lake that stores utility data*/
  coldSideHeatCapacity <-- queryDataLake( )
  /* Initialize time */
  time <-- 0
  /* Repeat the predictive calculation over the desired time horizon */
  repeat
    /* Call a thermodynamic system to calculate the hot side fluid properties */
    hotSideDensity, hotSide Viscosity, hotSideHeatCapacity <-- thermo( )
    /* Call a cloud-based weather API to obtain a forecast of ambient temperature */
    ambientTemp <-- cloudAPI( )
    /* Call a machine learning regression model to estimate the hot side pressure drop
    */
    hotSidePressureDrop <-- mlRegression( )
    /* Call a rigorous chemical simulator to calculate the heat transfer coefficient */
    htcArray <-- simulate( )
    /* Go to the next time point */
    time <-- time + 1
    /* Forecast input parameters at next time point */
    coldSideInletTemp <-- forecastColdSideInletTemp(coldSideInletTemp)
    coldSideOutletTemp <-- forecastColdSideOutletTemp(coldSideOutletTemp)
    hotSideInletTemp <-- forecastHotSideInletTemp(hotSideInletTemp)
    hotSideOutletTemp <-- forecastHotSideOutletTemp(hotSideOutletTemp)
    coldSideFlowrate <-- forecastColdSideFlowrate(coldSideFlowrate)
    hotSideFlowrate <-- forecastHotSideFlowrate(hotSideFlowrate)
  until (time >= forecastWindow)
  /* Convert heat transfer coefficients to desired unit of measure */
  htcArray2 <-- convertUOM(htcArray)
  /* Package results into expected format */
  outputs <-- packResults(htcArray2)
  /* Return results */
  return outputs
end procedure
```

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-based system predicting failures and degradation in industrial processing plant assets, comprising:
a prediction model configuration and testing assembly, for a given industrial processing plant formed of certain assets, the assembly configures one or more prediction models corresponding to the plant assets, different prediction models representing different plant assets and respective predicted failure and degradation; and
a model execution engine accessing diverse data sources and executing the prediction models, for execution of each prediction model, applying a combination of diverse calculators computing asset failure prediction of the plant asset corresponding to the prediction model, the diverse data sources and diverse calculators enhancing prediction quality.

2. The system as claimed in claim 1 wherein the model execution engine deploys the one or more prediction models detecting asset failures and equipment degradation in real time operations of the given industrial processing plant.

3. The system as claimed in claim 1 wherein the model execution engine selects plant measurements or tags as inputs to the one or more prediction models, wherein the tags may be direct plant measurements or custom tags created either by aggregating and combining the measured tags or created by applying transformations or engineering computations to the measurements, and the system maps the tags to prediction model variables allowing the model to be driven by real-time data when deployed online.

4. The system as claimed in claim 1 further comprising a database storing the computed asset failure predictions, the system treating the asset failure predictions as variables, and the database allowing the asset failure predictions to be used as inputs for another prediction model's calculation or for communication to the system's users and other parts of the system.

5. The system as claimed in claim 4 wherein the system allows the configuration and persistence of calculation parameters in the database.

6. The system as claimed in claim 1 wherein the system implements a flexible data structure for representing the prediction model's variables and parameters, thus allowing for a wide range of model types to be configured in the system.

7. The system as claimed in claim 1 wherein the system defines an extensible data format that allows it to exchange variable and parameter values and other information with the model execution engine.

8. The system as claimed in claim 1 wherein the model execution engine has a flexible interface enabling multiple data sources and multiple calculation methods to be combined together to compute the asset failure predictions.

9. The system as claimed in claim 1 wherein the prediction model configuration and testing assembly trains each prediction model independently using any appropriate dataset and then deploys to the model execution engine, which may run locally on a same machine as the model client or remotely on a network location.

10. The system as claimed in claim 1 wherein for each configured prediction model, when the prediction model is deployed online, the prediction model is used to monitor plant degradation and detect asset failures, the online model being driven by plant measurements of the given industrial processing plant and by other information sources.

11. A method for predicting failures and degradation in industrial processing plant assets, comprising:
configuring one or more prediction models corresponding to the plant assets, different prediction models representing different plant assets and respective predicted failure and degradation;
accessing diverse data sources; and
executing the prediction models, wherein the executing comprises applying a combination of diverse calculators computing asset failure prediction of the plant asset corresponding to the prediction model, the diverse data sources and diverse calculators enhancing prediction quality.

12. The method as claimed in claim 11 further comprising deploying the one or more prediction models detecting asset failures and equipment degradation in real time operations of the given industrial processing plant.

13. The method as claimed in claim 11 further comprising selecting plant measurements or tags as inputs to the one or more prediction models, wherein the tags may be direct plant measurements or custom tags created either by aggregating and combining the measured tags or created by applying transformations or engineering computations to the measurements, and mapping the tags to prediction model variables allowing the model to be driven by real-time data when deployed online.

14. The method as claimed in claim 11 further comprising storing the computed asset failure predictions, treating the asset failure predictions as variables, and allowing the asset failure predictions to be used as inputs for another prediction model's calculation or for communication to a system's users and other parts of the system.

15. The method as claimed in claim 11 further comprising implementing a flexible data structure for representing the prediction model's variables and parameters, thus allowing for a wide range of model types to be configured.

16. The method as claimed in claim 11 further comprising defining an extensible data format that allows the exchange of variable and parameter values and other information with a model execution engine.

17. The method as claimed in claim 11 further comprising combining multiple data sources and multiple calculation methods to compute the asset failure predictions.

18. The method as claimed in claim 11 wherein the configuring comprises training each prediction model independently using any appropriate dataset and then deploying to a model execution engine, which may nm locally on a same machine as the model client or remotely on a network location.

19. The method as claimed in claim 11 wherein for each configured prediction model, when the prediction model is deployed online, the prediction model is used to monitor plant degradation and detect asset failures, the online model being driven by plant measurements of the given industrial processing plant and by other information sources.

20. A computer program product, comprising: at least one non-transitory computer-readable storage medium providing at least a portion of the software instructions to:
configure one or more prediction models corresponding to the plant assets, different prediction models representing different plant assets and respective predicted failure and degradation;
access diverse data sources; and
execute the prediction models, wherein the executing comprises applying a combination of diverse calculators computing asset failure prediction of the plant asset corresponding to the prediction model, the diverse data sources and diverse calculators enhancing prediction quality.
